(19) United States
(12) Patent Application Publication
(10) Pub. No.: US 2008/0026199 A1
(43) Pub. Date: Jan. 31, 2008

(54) ADVERTISING SHEET

(75) Inventors: Hyung-Min CHA, Cheongju-si (KR); Youn-Woo NAM, Cheongju-si (KR)

Correspondence Address: CANTOR COLBURN, LLP, 55 GRIFFIN ROAD SOUTH, BLOOMFIELD, CT, 06002, US

(73) Assignee: LG CHEM, LTD., Seoul (KR)

(21) Appl. No.: 11/829,117

(22) Filed: Jul. 27, 2007

(30) Foreign Application Priority Data
Jul. 27, 2006 (KR) 10-2006-0070710

(51) Int. Cl. B32B 27/32

(52) U.S. Cl. 428/221; 428/500

(57) ABSTRACT

The present invention relates to a banner product capable of being used for hanging among the outdoor advertisement shapes. Therefore, the present invention provides a sheet for advertisement comprising a polyvinyl chloride resin as a surface layer, a polyolefin fabric or polyolefin film formed under the surface layer, and an additional adhesive layer formed between the above layers to ensure the adhesiveness. Thereby, the sheet for advertisement has excellent printability, and the use and handling of the sheet for advertisement is convenient due to reducing the total weight of the product.

This application claims the benefit of the filing date of Korean Patent Application No. 10-2006-0070710 filed on Jul. 27, 2006 in the Korean Intellectual Property Office, the disclosure of which is incorporated herein in its entirety by reference.

### BACKGROUND OF THE INVENTION

1. Field of the Invention

The present invention relates to a fabric product mainly used for hanging among the conventional outdoor materials for advertisement. More particularly, the present invention relates to a sheet for advertisement with excellent printability and lightweight.

2. Description of the Related Art

Currently, the most widely used sheet for advertisement is produced by placing a polyester woven fabric between two sheets of polyvinyl chloride resins and then heat pressing the sheets. Such a sheet for advertisement is excellent in printability and durability. However, there is a limitation in reducing the weight due to the inherent charateristics of fabric matierals. Especially, the sheet for advertisement with wide width is disadvantageous in handling and usage.

Korean Patent Application Laid-Open Publication No. 2004-74228 discloses a method for reducing the weight of a printing woven sheet for advertisement by forming a layer with a polyolefin fabric and a polyolefin resin. However, there is a disadvantage in that an additional coating layer must be formed in order to ensure printability.

Korean Patent Registration No. 452272 discloses a method for producing a PE banner for an advertising material, comprising extruding LDPE mixture via a T-DIE method, coating the LDPE mixture on both sides of a PET nonwoven fabric, and forming a primer layer on one surface of the fabric, where the LDPE mixture is uniformly coated by the pressure from an elastic roller engaged with a cooling roller, to improve adhesiveness when coating an inkjet for printing. However, there is a disadvantage in that an additional coating layer must be formed, in addition to a limitation in reducing weight due to use of a polyester (PET).

Korean Utility Model Registration No. 401068 discloses a banner sheet for advertisement having excellent printing quality comprising PVC sheets for forming dual surfaces, a PET sheet in the same size as the PVC sheets sandwiched between the PVC sheets via an adhesive layer. However, there is a limitation in reducing weight due to use of a polyester (PET).

### SUMMARY OF THE INVENTION

As described above, the conventional sheets for advertisement have disadvantages in printability and the product weight depending on each material used in the sheet for advertisement.

Therefore, the present invention has been made in view of the above problems, and it is an object of the present invention to provide a sheet for advertisement with excellent printability and lightweight by improving the above problems.

Moreover, the present invention is provided to ensure various use properties such as durability through ensuring adhesiveness between each different material, and to ensure low production cost through capability to process continuously in a roll shape.

In accordance with an aspect of the present invention, the above and other objects can be accomplished by the provision of a sheet for advertisement comprising, from the top, a surface layer of polyvinyl chloride, an adhesive layer, and a substrate layer of polyolefin.

In accordance with another aspect of the present invention, the above and other objects can be accomplished by the provision of the sheet for advertisement further comprising another adhesive layer and a reverse surface layer of polyvinyl chloride under the substrate layer.

It is preferable that the substrate layer has a specific gravity of 0.8 to 1.1.

Since conventional sheets for advertisement are made from polyester (specific gravity of about 1.4), they have a limitation in reducing the weight. However, the sheet of the present invention is made from polyolefin whose specific gravity is relatively as low as 0.9, and therefore, a lightweight product may be obtained.

Polyolefin is light in weight, but has relatively low printability and adhesiveness. Thus, printability and adhesiveness can be ensured by using a polyvinyl chloride resin having excellent printability as the surface layer and applying an additional adhesive layer.

The substrate layer is formed of a polyolefin fabric or polyolefin film, which is selected depending on the physical properties required during use for advertisement. In general, a fabric is used as the substrate layer when the sheet for advertisement requires flexibility or embossing effect of the printing surface depending on the fabric. On the other hand, a film is used as the substrate layer when an even printing surface is required.

In order to ensure adhesiveness between the substrate layer and the surface layer/reverse surface layer composed of different materials, it is preferable that the adhesive layer is formed of a polyester resin, and an isocyanate hardener which is mixed thereto for heat curing.

The sheet for advertisement of the present invention may be commercialized in two forms. That is, a product having a structure capable of dual surface advertising by allowing printing on both surfaces of the product (FIG. 1) and a product having a structure capable of printing on a single surface (FIG. 2) may be possible.

Specifically, a sheet for advertisement capable of a single surface printing comprises a surface layer composed of polyvinyl chloride resin, an adhesive layer below the surface layer, a polyolefin fabric or film layer below the adhesive layer. Furthermore, a sheet for advertisement capable of dual surface printing comprises a surface layer, an adhesive layer, a polyolefin fabric or film layer, an adhesive layer and a reverse surface layer.

The sheet for advertisement according to the present invention has structures illustrated in cross-sectional view of FIGS. 1 and 2. Thereby, the sheet for advertisement may ensure the same printability as with the conventional products formed of a surface layer composed of a polyvinyl chloride resin and a polyester fabric. Moreover, the sheet for advertisement may be produced with a lightweight, and its handling is easy. Furthermore, by using the polyolefin resin, it is possible to produce the sheet for advertisement with excellent printing quality and low cost compared with the conventional product which supplemented the printability by including an additional coating layer.

### BRIEF DESCRIPTION OF THE DRAWINGS

The above and other objects, features and other advantages of the present invention will be more clearly understood from the following detailed description taken in conjunction with the accompanying drawing(s), in which:

FIG. 1 is a cross-sectional view illustrating a sheet for advertisement according to the present invention capable of printing on dual surface of the sheet.

FIG. 2 is a cross-sectional view illustrating a sheet for advertisement according to the present invention capable of printing on a single surface of the sheet.

### DESCRIPTION OF THE PREFERRED EMBODIMENTS

The present invention will now be described in greater detail with reference to the drawings.

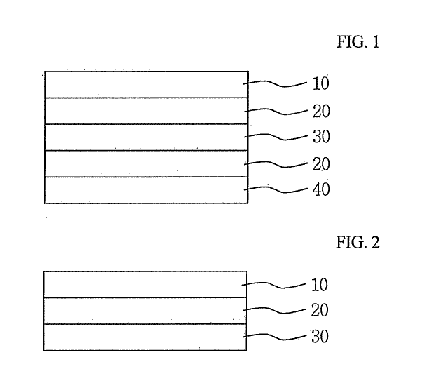

FIG. 1 is a cross-sectional view illustrating a sheet for advertisement according to the present invention capable of printing on dual surface of the sheet. The sheet for advertisement comprises, from the top, a surface layer 10, an adhesive layer 20, a polyolefin substrate layer 30, an adhesive layer 20 and a reverse surface layer 40.

The surface layer 10 and the reverse surface layer 40 are composed of a polyvinyl chloride resin having excellent printability. This structure is capable of printing on dual surface of the sheet.

The substrate layer 30 is composed of low-density polyolefin fabric or polyolefin film. Specifically, when using a polyolefin resin such as polyethylene or polypropylene a film or a fabric woven in a net shape is prepared. This process has already been disclosed in the conventional arts, thus detailed description thereof is omitted. The substrate layer 30 has a preferable thickness of about 10 to 200 μm.

Below the surface layer 10, the adhesive layer 20 using polyester resin as a main component is introduced. Thereby, adhesion of the surface layer 10 and the reverse surface layer 40 with the polyolefin fabric or polyolefin film 30 can be ensured.

FIG. 2 is a cross-sectional view illustrating a sheet for advertisement according to the present invention capable of printing on one surface of the sheet. The sheet for advertisement comprises, from the top, a surface layer 10, an adhesive layer 20, and a polyolefin fabric or polyolefin film 30.

The sheet for advertisement of FIG. 2 excluded the reverse surface layer 40 and the adhesive layer 20 on the reverse surface layer 40 of FIG. 1, thus a single surface printing is possible. The base materials are the same as described in the product of FIG. 1.

Hereinafter, the present invention will be explained in more detail with reference to the following examples. However, these examples are given for the purpose of illustration and are not to be construed as limiting the scope of the invention.

### EXAMPLES

### Example 1

Polypropylene film (specific gravity of 0.9) among polyolefin films having the thickness of 50 μm was used as the substrate layer 30. The surface layer 10 and the reverse surface layer 40 to be printed for advertisement were fabricated using a polyvinyl chloride and a base material including a plasticizer, a stabilizer or the like. The fabrication was carried out via a calendar method, and the thickness of the surface layer 10 and the reverse surface layer 40 were 150 μm.

In order to ensure the adhesiveness between the surface layer 10 and the polypropylene film 30, a composition having a polyester resin dissolved therein was coated by a Gravure coating method and then heated for 30 seconds in a drying oven at 100° C. Thereby, the adhesive layer 20 having the thickness of 2 μm was fabricated. At the end of the drying in the oven the above prepared surface layer 10 was heat pressed to fabricate a product capable of single surface printing.

### Example 2

Below the polypropylene film 30 of the product obtained in Example 1, an adhesive layer 20 was formed using the same coating method and raw materials. The readily prepared reverse surface layer 40 was heat pressed on the adhesive layer 20 to fabricate a product capable of dual surface printing.

The present invention relates to a banner product capable of being used for hanging among the outdoor advertisement shapes. The banner product comprises a polyvinyl chloride resin as a surface layer, a polyolefin fabric or polyolefin film formed below the surface layer, and an adhesive layer additionally formed between the above layers to ensure the adhesiveness. Thereby, the banner can realize the same printability with a conventional banner using a polyvinyl chloride material. The use and handing of the banner product is convenient due to reducing the total weight of the product. Moreover, it is possible to ensure excellent printing quality compared with the conventional product, which comprises polyolefin resin as the surface layer and an additional layer to allow printing. Furthermore, the production process of the banner product has been simplified, thereby it is possible to produce the banner with relatively low production cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A sheet for advertisement comprising, from the top, a surface layer of polyvinyl chloride, an adhesive layer, and a substrate layer of polyolefin.

2. The sheet according to claim 1, wherein the sheet for advertisement further comprising another adhesive layer and a reverse surface layer of polyvinyl chloride under the substrate layer.

3. The sheet according to claim 1, wherein the substrate layer has a specific gravity of 0.8 to 1.1.

4. The sheet according to claim 2, wherein the substrate layer has a specific gravity of 0.8 to 1.1.

5. The sheet according to claim 1, wherein the substrate layer is composed of a polyolefin fabric or film.

6. The sheet according to claim 2, wherein the substrate layer is composed of a polyolefin fabric or film.

7. The sheet according to claim 1, wherein the adhesive layer is composed of a polyester resin, and an isocyanate hardener which is mixed thereto for heat curing.

8. The sheet according to claim 2, wherein each of the adhesive layers is composed of a polyester resin, and an isocyanate hardener which is mixed thereto for heat curing.
